(19) United States
(12) Patent Application Publication
(10) Pub. No.: US 2024/0404007 A1
(43) Pub. Date: Dec. 5, 2024

(54) VIDEO SUPER-RESOLUTION METHOD AND DEVICE

(71) Applicant: Beijing Zitiao Network Technology Co., Ltd., Beijing (CN)

(72) Inventor: Hang DONG, Beijing (CN)

(21) Appl. No.: 18/696,896

(22) PCT Filed: Oct. 27, 2022
(86) PCT No.: PCT/CN2022/127873

§ 371 Date: Mar. 28, 2024

(30) Foreign Application Priority Data
Oct. 28, 2021 (CN) 202111266280.7

(51) Int. Cl. G06T 3/4053; G06T 5/73; G06T 7/246; G06T 7/33

(52) U.S. Cl. CPC G06T 3/4053; G06T 5/73; G06T 7/248; G06T 7/337; G06T 2207/10016; G06T 2207/20221

(57) ABSTRACT

Embodiments of the present invention provide a video super-resolution method and apparatus, the method including: acquiring a first feature; processing the first feature by concatenated multistage residual dense blocks (RDBs) to obtain a fusion feature output by a RDB in each stage; for the fusion feature output by the RDB in each stage, aligning each of neighborhood features of the fusion feature with a target feature of the fusion feature to obtain an alignment feature corresponding to the RDB that outputs the fusion feature; and generating a super-resolution video frame corresponding to the target video frame on the basis of the alignment feature corresponding to the RDB in each stage and the initial feature of the target video frame.

### CROSS-REFERENCE TO RELATED APPLICATION

The present application claims the priority to Chinese Patent Application No. 202111266280.7, filed on Oct. 28, 2021 and named “VIDEO SUPER-RESOLUTION METHOD AND APPARATUS”, the entire content of which is incorporated herein by reference in the present application.

### TECHNICAL FIELD

The present invention relates to the field of image processing technology, and in particular, to a video super-resolution method and apparatus.

### BACKGROUND

Video super-resolution technology is a technology to recover a high-resolution video from a low-resolution video. Because video super-resolution service has now become a key service in video image quality enhancement, video super-resolution technology is one of the current research hotspots in the field of image processing.

Video super-resolution is commonly implemented in the prior art by the constructed and trained video super-resolution networks, however, the video super-resolution networks in the prior art are often constructed and trained for clear low-resolution video. Although these video super-resolution networks constructed and trained for clear low-resolution video is able to recover a high-resolution video on the basis of an input clear low-resolution video, there is often a movement during the actual video shooting, and the captured video not only suffers from the loss of high-frequency details, but also suffers from the severe motion blur. For the blurry low-resolution video with both the loss of high-frequency details and the motion blur, the video super-resolution networks in the prior art cannot simultaneously achieve the effect of detail recovery and blur removal, thus having poor super-resolution effect.

### SUMMARY

In view of this, the present invention provides a video super-resolution method and apparatus, for solving the problem of poor super-resolution effect of blurry low-resolution video in the prior art.

In order to achieve the above objects, the embodiments of the present invention provide the following technical solutions:

In a first aspect, embodiments of the present invention provide a video super-resolution method, including:
acquiring a first feature, wherein the first feature is a feature obtained by merging an initial feature of a target video frame and an initial feature of each of neighborhood video frames of the target video frame;
processing the first feature by concatenated multistage residual dense blocks (RDBs) to obtain a fusion feature output by a RDB in each stage;
for the fusion feature output by the RDB in each stage, aligning each of neighborhood features of the fusion feature with a target feature of the fusion feature to obtain an alignment feature corresponding to the RDB that outputs the fusion feature, wherein each of the neighborhood features of the fusion feature is a feature corresponding to each of the neighborhood video frames, and the target feature of the fusion feature is a feature corresponding to the target video frame; and
generating a super-resolution video frame corresponding to the target video frame on the basis of the alignment feature corresponding to the RDB in each stage and the initial feature of the target video frame.

As an optional implementation of the embodiment of the present invention, that aligning each of neighborhood features of the fusion feature with a target feature of the fusion feature to obtain an alignment feature corresponding to the RDB that outputs the fusion feature, includes:
acquiring an optical flow between each of the neighborhood video frames and the target video frame respectively; and
aligning each of neighborhood features of the fusion feature with a target feature of the fusion feature on the basis of the optical flow between each of the neighborhood video frames and the target video frame, to obtain an alignment feature corresponding to the RDB that outputs the fusion feature.

As an optional implementation of the embodiment of the present invention, that aligning each of neighborhood features of the fusion feature with a target feature of the fusion feature on the basis of the optical flow between each of the neighborhood video frames and the target video frame, to obtain an alignment feature corresponding to the RDB that outputs the fusion feature, includes:
splitting the fusion feature to obtain each of the neighborhood features and the target feature;
aligning each of the neighborhood features with the target feature on the basis of the optical flow between each of the neighborhood video frames and the target video frame, to obtain an alignment feature for each of the neighborhood video frames; and
merging the target feature and the alignment feature of each of the neighborhood video frames to obtain an alignment feature corresponding to the RDB that outputs the fusion feature.

As an optional implementation of the embodiment of the present invention, that aligning each of neighborhood features of the fusion feature with a target feature of the fusion feature to obtain an alignment feature corresponding to the RDB that outputs the fusion feature, includes:
upsampling the target video frame and each of the neighborhood video frames of the target video frame, to obtain an upsampled video frame of the target video frame and an upsampled video frame of each of the neighborhood video frames;
acquiring an optical flow between the upsampled video frame of each of the neighborhood video frames and the upsampled video frame of the target video frame respectively; and
aligning each of the neighborhood features of the fusion feature with the target feature of the fusion feature on the basis of the optical flow between the upsampled video frame of each of the neighborhood video frames and the upsampled video frame of the target video frame, to obtain an alignment feature corresponding to the RDB that outputs the fusion feature.

As an optional implementation of the embodiment of the present invention, that aligning each of the neighborhood features of the fusion feature with the target feature of the fusion feature on the basis of the optical flow between the upsampled video frame of each of the neighborhood video frames and the upsampled video frame of the target video frame, to obtain an alignment feature corresponding to the RDB that outputs the fusion feature, includes:
splitting the fusion feature to obtain each of the neighborhood features and the target feature;
upsampling each of the neighborhood features and the target feature respectively, to obtain an upsampled feature of each of the neighborhood video frames and an upsampled feature of the target video frame;
aligning the upsampled feature of each of the neighborhood video frames with the upsampled feature of the target video frame on the basis of the optical flow between the upsampled video frame of each of the neighborhood video frames and the upsampled video frame of the target video frame, to obtain an upsampled alignment feature of each of the neighborhood video frames;
performing a space-to-depth conversion on the upsampled feature of the target video frame and the upsampled aligned feature of each of the neighborhood video frames respectively, to obtain an equivalent feature of the target video frame and an equivalent feature of each of the neighborhood video frames; and
merging the equivalent feature of the target video frame and the equivalent feature of each of the neighborhood video frames, to obtain an alignment feature corresponding to the RDB that outputs the fusion features.

As an optional implementation of the embodiment of the present invention, that generating a super-resolution video frame corresponding to the target video frame on the basis of the alignment feature corresponding to the RDB in each stage and the initial feature of the target video frame, includes:
merging alignment features corresponding to the multistage RDBs to obtain a second feature;
converting, based on a feature conversion network, the second feature into a feature having the same tensor as an initial feature of the target video frame to obtain a third feature; and
generating a super-resolution video frame corresponding to the target video frame on the basis of the third feature and the initial feature of the target video frame.

As an optional implementation of the embodiment of the present invention, the feature conversion network includes a first convolutional layer, a second convolutional layer, and a third convolutional layer concatenated sequentially;
the first convolutional layer has a kernel of 1*1*1 and has a padding parameter of 0 in each dimension; and
the second convolutional layer and the third convolutional layer both have a kernel of 3*3*3 and have a padding parameter of 0 in a time dimension and a padding parameter of 1 in both length dimension and width dimension.

As an optional implementation of the embodiment of the present invention, that generating a super-resolution video frame corresponding to the target video frame on the basis of the third feature and the initial feature of the target video frame, includes:
performing summation fusion on the third feature and the initial feature of the target video frame to obtain a fourth feature;
processing the fourth feature by a residual dense network RDN to obtain a fifth feature; and
upsampling the fifth feature to obtain a super-resolution video frame corresponding to the target video frame.

In a second aspect, embodiments of the present invention provides a video super-resolution apparatus, includes:
an acquisition unit, configured to acquire a first feature, wherein the first feature is a feature obtained by merging an initial feature of a target video frame and an initial feature of each of neighborhood video frames of the target video frame;
a processing unit, configured to process the first feature by concatenated multistage residual dense blocks (RDBs) to obtain a fusion feature output by a RDB in each stage;
an alignment unit, configured to, for the fusion feature output by the RDB in each stage, align each of neighborhood features of the fusion feature with a target feature of the fusion feature to obtain an alignment feature corresponding to the RDB that outputs the fusion feature, wherein each of the neighborhood features of the fusion feature is a feature corresponding to each of the neighborhood video frames, and the target feature of the fusion feature is a feature corresponding to the target video frame; and
a generation unit, configured to generate a super-resolution video frame corresponding to the target video frame on the basis of the alignment feature corresponding to the RDB in each stage and the initial feature of the target video frame.

As an optional implementation of the embodiment of the present invention, the alignment unit, specifically configured to acquire an optical flow between each of the neighborhood video frames and the target video frame respectively; and align each of neighborhood features of the fusion feature with a target feature of the fusion feature on the basis of the optical flow between each of the neighborhood video frames and the target video frame, to obtain an alignment feature corresponding to the RDB that outputs the fusion feature.

As an optional implementation of the embodiment of the present invention, the alignment unit, specifically configured to split the fusion feature to obtain each of the neighborhood features and the target feature; align each of the neighborhood features with the target feature on the basis of the optical flow between each of the neighborhood video frames and the target video frame, to obtain an alignment feature for each of the neighborhood video frames; and merge the target feature and the alignment feature of each of the neighborhood video frames to obtain an alignment feature corresponding to the RDB that outputs the fusion feature.

As an optional implementation of the embodiment of the present invention, the alignment unit, specifically configured to upsample the target video frame and each of the neighborhood video frames of the target video frame, to obtain an upsampled video frame of the target video frame and an upsampled video frame of each of the neighborhood video frames; acquire an optical flow between the upsampled video frame of each of the neighborhood video frames and the upsampled video frame of the target video frame; and align each of the neighborhood features of the fusion feature with the target feature of the fusion feature on the basis of the optical flow between the upsampled video frame of each of the neighborhood video frames and the upsampled video frame of the target video frame, to obtain an alignment feature corresponding to the RDB that outputs the fusion feature.

As an optional implementation of the embodiment of the present invention, the alignment unit, specifically configured to split the fusion feature to obtain each of the neighborhood features and the target feature; upsample each of the neighborhood features and the target feature respectively, to obtain an upsampled feature of each of the neighborhood video frames and an upsampled feature of the target video frame; align the upsampled feature of each of the neighborhood video frames with the upsampled feature of the target video frame on the basis of the optical flow between the upsampled video frame of each of the neighborhood video frames and the upsampled video frame of the target video frame, to obtain an upsampled alignment feature of each of the neighborhood video frames; perform a space-to-depth conversion on the upsampled feature of the target video frame and the upsampled aligned feature of each of the neighborhood video frames respectively, to obtain an equivalent feature of the target video frame and an equivalent feature of each of the neighborhood video frames; and merge the equivalent feature of the target video frame and the equivalent feature of each of the neighborhood video frames, to obtain an alignment feature corresponding to the RDB that outputs the fusion features.

As an optional implementation of the embodiment of the present invention, the generation unit specifically configured to merge alignment features corresponding to the multistage RDBs to obtain a second feature; convert, based on a feature conversion network, the second feature into a feature having the same tensor as an initial feature of the target video frame to obtain a third feature; and generate a super-resolution video frame corresponding to the target video frame on the basis of the third feature and the initial feature of the target video frame.

As an optional implementation of the embodiment of the present invention, the feature conversion network includes a first convolutional layer, a second convolutional layer, and a third convolutional layer concatenated sequentially;

the first convolutional layer has a kernel of 1*1*1 and has a padding parameter of 0 in each dimension; and

the second convolutional layer and the third convolutional layer both have a kernel of 3*3*3 and have a padding parameter of 0 in a time dimension and a padding parameter of 1 in both length dimension and width dimension.

As an optional implementation of the embodiment of the present invention, the generation unit specifically configured to perform summation fusion on the third feature and the initial feature of the target video frame to obtain a fourth feature; process the fourth feature by a residual dense network RDN to obtain a fifth feature; and upsample the fifth feature to obtain a super-resolution video frame corresponding to the target video frame.

In a third aspect, embodiments of the present invention provides an electronic device, includes: a memory and a processor, the memory being configured to store a computer program, the processor being configured to, when executing the computer program, cause the electronic device to implement the video super-resolution method of the first aspect or any optional implementation of the first aspect.

In a fourth aspect, embodiments of the present invention provides a computer-readable storage medium, in the case where a computer program is executed by a computing device, the computer-readable storage medium causes the computing device to implement the video super-resolution method of the first aspect or any optional implementation of the first aspect.

In a fifth aspect, embodiments of the present invention provides a computer program product, when run on a computer, the computer program product causing the computer to implement the video super-resolution method of the first aspect or any optional implementation of the first aspect.

The video super-resolution method of the embodiments of the present invention, when used for performing video super-resolution, includes: firstly acquiring a first feature that is obtained by merging an initial feature of a target video frame and an initial feature of each of neighborhood video frames of the target video frame, then processing the first feature by concatenated multistage residual dense blocks (RDBs) to obtain a fusion feature output by a RDB in each stage; further, for the fusion feature output by the RDB in each stage, aligning each of neighborhood features of the fusion feature with a target feature of the fusion feature to obtain an alignment feature corresponding to the RDB that outputs the fusion feature, and finally generating a super-resolution video frame corresponding to the target video frame on the basis of the alignment feature corresponding to the RDB in each stage and the initial feature of the target video frame. In the video super-resolution method of the embodiments of the present invention, because each of the neighboring features of the fusion feature output by the RDB in each stage is aligned with the target feature, the embodiments of the present invention can achieve the effect of detail recovery and blur removal at the same time, thus solving the problem of poor super-resolution effect of blurry low-resolution video in the prior art.

### BRIEF DESCRIPTION OF THE DRAWINGS

The accompanying drawings, which are incorporated in and constitute a part of this specification, illustrate embodiments consistent with the present invention and, together with the specification, serve to explain the principles of the present invention.

To describe the technical solutions in the embodiments of the present invention or in the prior art more clearly, the following briefly describes the accompanying drawings required for the embodiments or the prior art, apparently, persons of ordinary skill in the art may still derive other drawings from these accompanying drawings without creative efforts.

FIG. 1 is a flowchart I of a video super-resolution method according to an embodiment of the present invention;

FIG. 2 is a schematic diagram I of a model structure for a video super-resolution method according to an embodiment of the present invention;

FIG. 3 is a schematic diagram II of a data stream of a video super-resolution method according to an embodiment of the present invention;

FIG. 4 is a schematic diagram II of a model structure for a video super-resolution method according to an embodiment of the present invention;

FIG. 5 is a schematic diagram III of a model structure for a video super-resolution method according to an embodiment of the present invention;

FIG. 6 is a flowchart III of a video super-resolution method according to an embodiment of the present invention;

FIG. 7 is a schematic diagram IV of a model structure for a video super-resolution method according to an embodiment of the present invention;

FIG. 8 is a schematic diagram of a video super-resolution apparatus according to an embodiment of the present invention; and

FIG. 9 is a schematic diagram of a hardware structure of an electronic device according to an embodiment of the present invention.

### DETAILED DESCRIPTION

To more clearly understand the above objectives, features, and advantages in the present invention, the following further describes the solutions of the present invention. It should be noted that, without conflict, the embodiments and features in the embodiments in the present invention may be combined with each other.

The following illustrates many specific details for full understanding of the present invention, but the present invention may also be implemented in other ways different from those described herein. Apparently, the described embodiments in the specification are only some rather than all of the embodiments of the present invention.

In the embodiments of the present invention, the terms such as “illustratively” or “for example” are used to indicate an example, illustration, or description. Any embodiment or design solution described as “illustratively” or “for example” in the embodiments of the present invention should not be construed as being preferred or advantageous over other embodiments or design solutions. Rather, the use of the terms such as “illustratively” or “for example” are intended to present the relevant concepts in a specific manner. Furthermore, in the description of the present invention, “a plurality of” means two or more than two, unless otherwise stated.

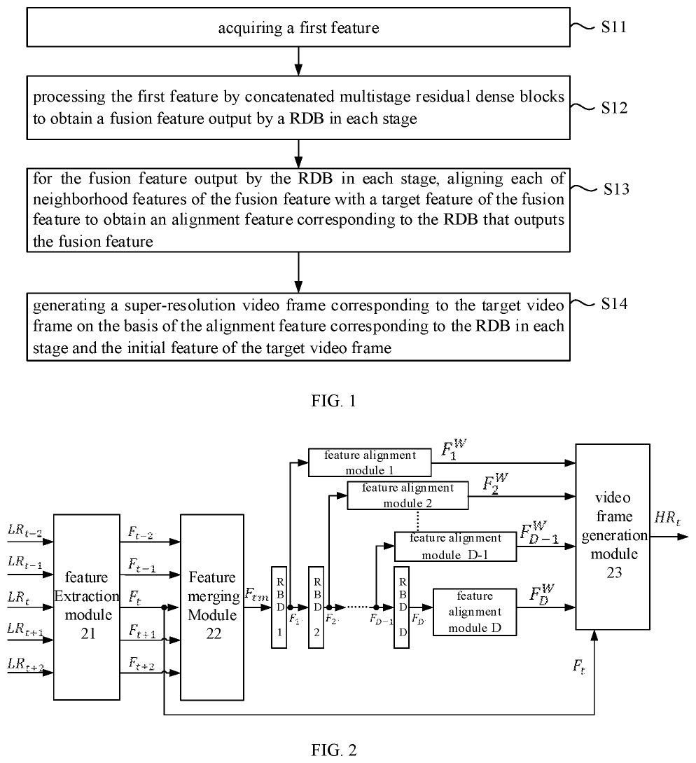

An embodiment of the present invention provides a video super-resolution method, with reference to FIG. 1, the video super-resolution method includes the following steps.

S11: acquiring a first feature.

The first feature is a feature obtained by merging an initial feature of a target video frame and an initial feature of each of neighborhood video frames of the target video frame.

Each of the neighborhood video frames of the target video frame in the embodiment of the present invention may be all the video frames within a preset neighborhood range of the target video frame. For example, in the case where the preset neighborhood range is 2, and the target video frame is an nth video frame of a video to be subjected to super resolution, the neighborhood video frames of the target video frame include: a (n−2)^{th} video frame, a (n−1)^{th} video frame, a (n+1)^{th} video frame, and a (n+2)^{th} video frame of the video to be subjected to super resolution; and the first feature is a feature obtained by merging the (n−2)^{th} video frame, the (n−1)^{th} video frame, the n^{th} video frame, the (n+1)^{th} video frame, and the (n+2)^{th} video frame of the video to be subjected to super resolution.

Optionally, an implementation of acquiring a first feature may include Step a and Step b as follows.

Step a: acquiring an initial feature of a target video frame and an initial feature of each of neighborhood video frames of the target video frame.

Specifically, the same convolutional layer may be used to perform feature extraction on the target video frame and each of the neighborhood video frames of the target video frame respectively, so as to obtain the initial feature of the target video frame and the initial feature of each of the neighborhood video frames of the target video frame; alternatively, multiple convolutional layers sharing the same parameters may be used to perform feature extraction on the target video frame and each of the neighborhood video frames of the target video frame respectively, so as to obtain the initial feature of the target video frame and the initial feature of each of the neighborhood video frames of the target video frame.

Step b: merging the initial feature of the target video frame and the initial feature of each of the neighborhood video frames of the target video frame to obtain the first feature.

S12: processing the first feature by concatenated multistage residual dense blocks (RDBs) to obtain a fusion feature output by a RDB in each stage.

The concatenated multistage RDBs in the embodiment of the present invention refers to using an output of a previous-stage RDB as an output of a next-stage RDB. The RDB in each stage mainly includes three parts, namely a part of Contiguous Memory (CM), a part of Local Feature Fusion (LFF), and a part of Local Residual Learning (LRL). The part of CM is mainly used to send the output of the previous-stage RDB to each convolutional layer in a current-stage RDB. The part of LFF is mainly used to fuse the output of the previous-stage RDB with outputs of all the convolutional layers of the current-stage RDB. The part of LRL is mainly used to sum up the output of the previous-stage RDB with an output of the part of LFF of the current-stage RDB, and the summed result is used as an output of the current-stage RDB.

S13: for the fusion feature output by the RDB in each stage, aligning each of neighborhood features of the fusion feature with a target feature of the fusion feature to obtain an alignment feature corresponding to the RDB that outputs the fusion feature.

Each of the neighborhood features of the fusion feature is a feature corresponding to each of the neighborhood video frames, and the target feature of the fusion feature is a feature corresponding to the target video frame.

Specifically, because outputs of the multistage RDBs are all features obtained by processing the first feature one or more times that is obtained by merging the initial feature of the target video frame and the initial feature of each of the neighborhood video frames of the target video frame, the output of the RDB in each stage includes the target feature corresponding to the target video frame, and a neighborhood feature corresponding to each of the neighborhood video frames of the target video frame.

Further, that aligning the neighborhood feature with the target feature in the embodiment of the present invention refers to: matching features, used to characterize the same object in the neighborhood features and the target features.

Optionally, it is possible to align each of neighborhood features of the fusion feature with a target feature of the fusion feature on the basis of an optical flow between the target video frame and each of the neighborhood video frames.

The above step S13 is performed for the fusion feature output by the RDB in each stage, so that the alignment feature corresponding to the RDB in each stage can be obtained.

S14: generating a super-resolution video frame corresponding to the target video frame on the basis of the alignment feature corresponding to the RDB in each stage and the initial feature of the target video frame.

Illustratively, referring to FIG. 2, FIG. 2 is a schematic structural diagram of a video super-resolution network model used for implementing a video super-resolution method according to an embodiment of the present invention. The network model includes: a feature extraction module 21, a feature merging module 22, a plurality of concatenated RDBs (RDB 1, RDB 2, . . . RDB D), and a video frame generation module 23. The process that the video super-resolution network model illustrated in FIG. 2 performs the steps in the embodiment illustrated in FIG. 1 may include:

firstly, by the feature extraction module 21, extracting features from a target video frame LRₜ and each of neighborhood video frames (LRₜ₋₂, LRₜ₋₁, LRₜ₊₂, and LRₜ₊₁) of the target video frame LRₜ to obtain an initial feature Fₜ of LRₜ, an initial feature Fₜ₋₂ of LRₜ₋₂, an initial feature Fₜ₋₁ of LRₜ₋₁, an initial feature Fₜ₊₁ of LRₜ₊₁, and an initial feature Fₜ₊₂ of LRₜ₊₂; and by the feature merging module 22, merging Fₜ₋₂, Fₜ₋₁, Fₜ, Fₜ₊₁ and Fₜ₊₂ to obtain a first feature Fₜₘ;

secondly, processing the first feature Fₜₘ by the RDBs concatenated in D stages, where an input of a first-stage RDB is the first feature Fₜₘ, a fusion feature output by the first-stage RDB is F₁, an input of a second-stage RDB is the fusion feature F₁ output by the first-stage RDB, a fusion feature output by the second-stage RDB is F₂, an input of the D^{th}-stage RDB is a fusion feature F_{D-1} output by the (D−1)^{th}-stage RDB, a fusion feature output by the D^{th}-stage RDB is F_{D}, and thus the obtained fusion features output by the RDBs in different stages are F₁, F₂, . . . F_{D-1}, and F_{D} sequentially;

thirdly, aligning a feature corresponding to each of the neighborhood video frames of the fusion features (F₁, F₂, . . . , F_{D-1} and F_{D}) output by the RDB in each stage with a feature corresponding to the target video frame by a feature alignment module (a feature alignment module 1, a feature alignment module 2, . . . , and a feature alignment feature D) corresponding to the RDB in each stage, to obtain an alignment feature corresponding to the RDB in each stag, where the obtained alignment features corresponding to the multistage RDBs include: F₁^{W}, F₁^{W}, . . . , F_{D-1}^{W}, and F_{D}^{W}; and

finally, by the video frame generation module 23, processing the alignment features (F₁^{W}, F₂^{W}, . . . , F_{D-1}^{W}, and F_{D}^{W}) corresponding to RDBs in different stages and the initial feature Fₜ of the target video frame, to obtain the super-resolution video frame HRₜ corresponding to the target video frame.

It is to be noted that, the neighborhood video frames of the target video frame including four video frames is taken as an example for illustration in FIG. 2, but the embodiments of the present invention are not limited thereto. The neighborhood video frames of the target video frame in the embodiments of the prevent invention may include other number of video frames, for example, including two adjacent video frames, and for another example, including six video frames with a neighborhood range of 3, and the like.

The video super-resolution method of the embodiment of the present invention, when used for performing video super-resolution, includes: firstly acquiring a first feature that is obtained by merging an initial feature of a target video frame and an initial feature of each of neighborhood video frames of the target video frame, then processing the first feature by concatenated multistage residual dense blocks (RDBs) to obtain a fusion feature output by a RDB in each stage; further, for the fusion feature output by the RDB in each stage, aligning each of neighborhood features of the fusion feature with a target feature of the fusion feature to obtain an alignment feature corresponding to the RDB that outputs the fusion feature, and finally generating a super-resolution video frame corresponding to the target video frame on the basis of the alignment feature corresponding to the RDB in each stage and the initial feature of the target video frame. In the video super-resolution method of the embodiments of the present invention, because each of the neighboring features of the fusion feature output from the RDB in each stage is aligned with the target feature, the embodiment of the present invention can achieve the effect of detail recovery and blur removal at the same time, thus solving the problem of poor super-resolution effect of blurry low-resolution video in the prior art.

It is further to be noted that because RDBs are concatenated in multiple stages, the alignment feature corresponding to the RDB in each stage will not affect the input (i.e., the fusion feature output by the previous-stage RDB) of the subsequently concatenated RDB; moreover, with the increase in the number of RDBs, blurry features will be recovered gradually, and therefore ghost images can further be reduced to further improve the video super-resolution effect in the embodiment of the present invention.

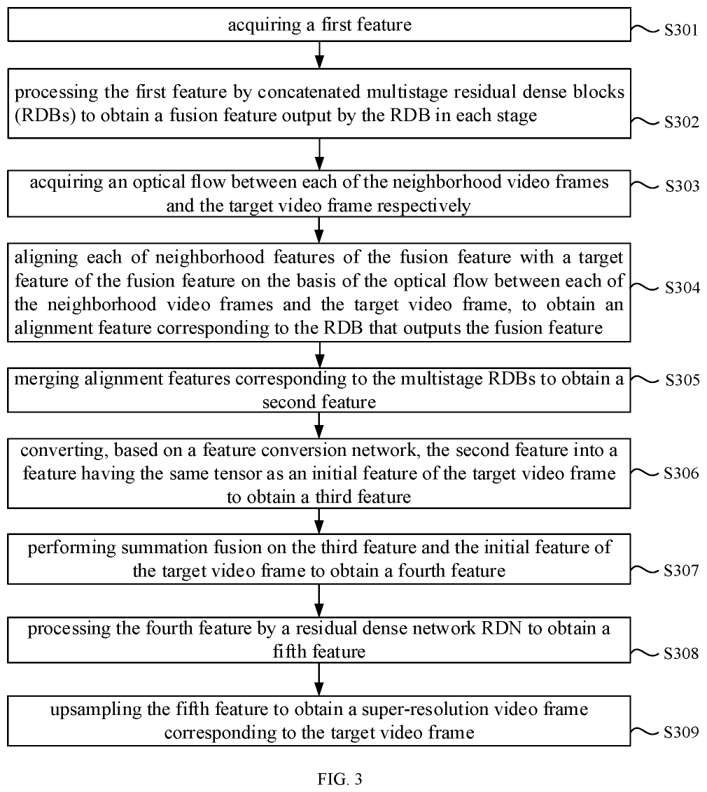

As an extension and detail of the above embodiment, an embodiment of the present invention provides another video super-resolution method, which includes the following steps, as illustrated in FIG. 3.

S301: acquiring a first feature.

The first feature is a feature obtained by merging an initial feature of a target video frame and an initial feature of each of neighborhood video frames of the target video frame.

S302: processing the first feature by concatenated multistage residual dense blocks (RDBs) to obtain a fusion feature output by the RDB in each stage.

S303: acquiring an optical flow between each of the neighborhood video frames and the target video frame respectively.

Optionally, it is possible to acquire an optical flow between each of the neighborhood video frames and the target video frame respectively by a pre-trained optical flow network model.

It should be noted that the embodiments of the present invention do not limit an order of acquiring the fusion feature output by the RDB in each stage and acquiring the optical flow between each of the neighborhood video frames and the target video frame; it is possible to acquire the fusion feature output by the RDB in each stage before acquiring the optical flow between each of the neighborhood video frames and the target video frame; it is possible to acquire the optical flow between each of the neighborhood video frames and the target video frame before acquiring the fusion feature output by the RDB in each stage; and it is also possible to carry out the two at the same time.

S304: aligning each of neighborhood features of the fusion feature with a target feature of the fusion feature on the basis of the optical flow between each of the neighborhood video frames and the target video frame, to obtain an alignment feature corresponding to the RDB that outputs the fusion feature.

As an optional implementation of the embodiment of the present invention, the implementation of the above step S304 may include Step a to Step c as below:
Step a: splitting the fusion feature to obtain each of the neighborhood features and the target feature;
Step b: aligning each of the neighborhood features with the target feature on the basis of the optical flow between each of the neighborhood video frames and the target video frame, to obtain an alignment feature for each of the neighborhood video frames; and
Step c: merging the target feature and the alignment feature of each of the neighborhood video frames to obtain an alignment feature corresponding to the RDB that outputs the fusion feature.

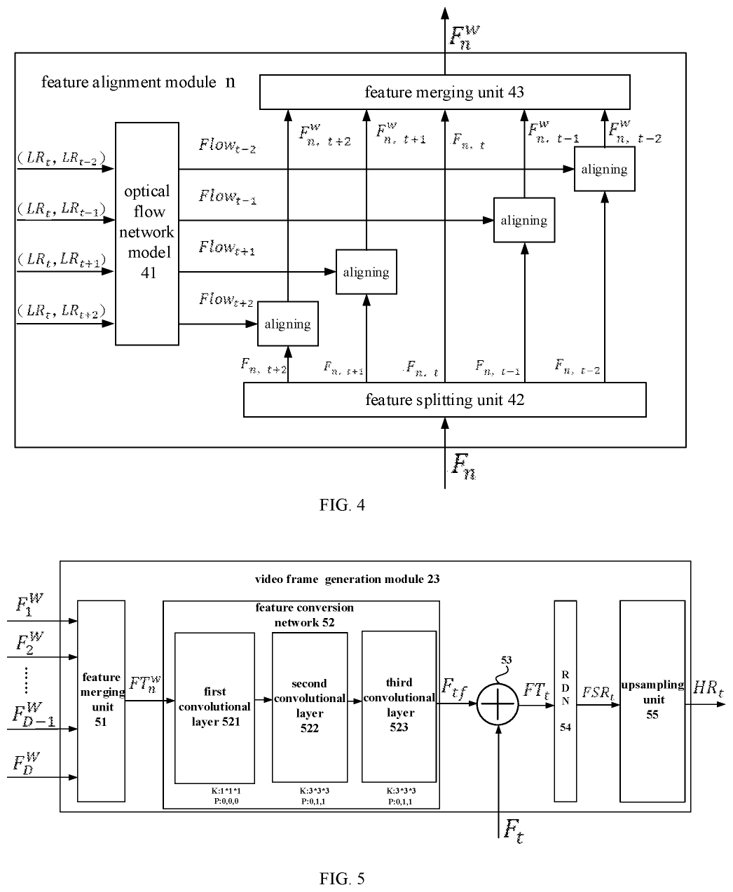

Refer to FIG. 4, FIG. 4 is a schematic structural diagram of a feature alignment module n in the embodiment illustrated in FIG. 2. The feature alignment module n includes: an optical flow network model 41, a feature splitting unit 42, and a feature merging unit 43. The process of acquiring the alignment feature corresponding to the RDB may include:
firstly, by the optical flow network model 41, acquiring an optical flow Flowₜ₋₂ between the neighborhood video frame LRₜ₋₂ and the target video frame LRₜ, an optical flow Flowₜ₋₁ between the neighborhood video frame LRₜ₋₁ and the target video frame LRₜ, an optical flow Flowₜ₊₁ between the neighborhood video frame LRₜ₊₁ and the target video frame LRₜ, an optical flow Flowₜ₊₂ between the neighborhood video frame LRₜ₊₂ and the target video frame LRₜ;
secondarily, by the feature splitting unit 42, splitting a fusion feature Fₙ output by an nth-stage RDB into a feature F_{n, t} corresponding to the target video frame LRₜ, a feature F_{n, t-2} corresponding to the neighborhood video frame LRₜ₋₂, a feature F_{n, t-1} corresponding to the neighborhood video frame LRₜ₋₁, a feature F_{n, t+1} corresponding to the neighborhood video frame LRₜ₊₁ and a feature F_{n, t+2} corresponding the neighborhood video frame LRₜ₊₂, respectively;
thirdly, aligning the feature F_{n, t+2} corresponding to the neighborhood video frame LRₜ₊₂ with the feature F_{n, t} corresponding to the target video frame LRₜ on the basis of the optical flow Flowₜ₊₂ between the neighborhood video frame LRₜ₊₂ and the target video frame LRₜ so as to obtain an alignment feature F_{n, t+2}^{w} of the neighborhood video frame LRₜ₊₂; aligning the feature F_{n, t+1} corresponding to the neighborhood video frame LRₜ₊₁ with the feature F_{n, t} corresponding to the target video frame LRₜ on the basis of the optical flow Flowₜ₊₁ between the neighborhood video frame LRₜ₊₁ and the target video frame LRₜ so as to obtain an alignment feature F_{n, t+1}^{w} of the neighborhood video frame LRₜ₊₁; aligning the feature F_{n, t-1} corresponding to the neighborhood video frame LRₜ₋₁ with the feature F_{n, t} corresponding to the target video frame LRₜ on the basis of the optical flow Flowₜ₋₁ between the neighborhood video frame LRₜ₋₁ and the target video frame LRₜ so as to obtain an alignment feature F_{n, t-1}^{w} of the neighborhood video frame LRₜ₋₁; and aligning the feature F_{n, t-2} corresponding to the neighborhood video frame LRₜ₋₂ with the feature F_{n, t} corresponding to the target video frame LRₜ on the basis of the optical flow Flowₜ₋₂ between the neighborhood video frame LRₜ₋₂ and the target video frame LRₜ so as to obtain an alignment feature F_{n, t-2}^{w} of the neighborhood video frame LRₜ₋₂; and
finally, by the feature merging unit 43, merging the feature F_{n, t} corresponding to the target video frame to the alignment features (F_{n, t+1}^{w}, F_{n, t+1}^{w}, F_{n, t-1}^{w} and F_{n, t-2}^{w}) of the neighborhood video frames to obtain an alignment feature Fₙ^{w} corresponding a target RDB.

The alignment feature corresponding to the RDB in each stage of the concatenated multistage RDBs is obtained in accordance with the method of Step a to Step c above sequentially, so that the alignment feature corresponding to the RDB in each stage is obtained.

S305: merging alignment features corresponding to the multistage RDBs to obtain a second feature.

S306: converting, based on a feature conversion network, the second feature into a feature having the same tensor as an initial feature of the target video frame to obtain a third feature.

Letting: a batch size of a convolutional layer used for feature extraction of the target video frame and the neighborhood video frames of the target video frame be n, a number of outputting channels be 64, a length of the video frame be h, and a width of the video frame be w, then tensors of the initial feature Fₜ of LRₜ, the initial feature Fₜ₋₂ of LRₜ₋₂, the initial feature Fₜ₋₁ of LRₜ₋₁, the initial feature Fₜ₊₁ of LRₜ₊₁, and the initial feature Fₜ₊₂ of LRₜ₊₂ are all n*64*h*w. In the case where there are four neighborhood video frames of the target video frame, a tensor of the first feature Fₜₘ is n*64*5*h*w and a tensor of the second feature FTₙ^{w} is n*(64*D)*5*h*w.

As described above, the tensor of the second feature FTₙ^{w} is n*(64*D)*5*h*w, the tensor of the initial feature Fₜ of the target video frame LRₜ is n*64*h*w, therefore a tensor of the third feature is n*64*h*w; and the step S306 described above is to convert the second feature FTₙ^{w} having a feature tensor of n*(64*D)*5*h*w into the third feature having a feature tensor of n*64*h*w.

Optionally, the feature processing module includes a feature conversion network, and the feature conversion network includes a first convolutional layer, a second convolutional layer and a third convolutional layer.

The first convolutional layer has a kernel of 1*1*1 and has a padding parameter of 0 in each dimension; and the second convolutional layer and the third convolutional layer both have a kernel of 3*3*3 and have a padding parameter of 0 in a time dimension and a padding parameter of 1 in both length dimension and width dimension.

Further optionally, the first convolutional layer has a number of inputting channels of 64*D, a number of outputting channels of 64 and a stride of 1, the second convolutional layer and the third convolutional layer both have a number of inputting channels of 64, a number of outputting channels of 64 and a stride of 1.

Because the first convolutional layer has a kernel of 1*1*1 and the padding parameter of 0 in each dimension, a tensor of the feature output by the first convolutional layer is n*64*5*h*w. Moreover, because the second convolutional layer 522 has a kernel of 3*3*3 and a padding parameter of 0 in the time dimension and 1 in both the length dimension and the width dimension, a tensor of the feature output by the second convolutional layer is n*64*2*h*w. Furthermore, because the third convolutional layer has a kernel of 3*3*3 and a padding parameter of 0 in the time dimension and 1 in both the length dimension and the width dimension, a tensor of the feature (third feature) output by the third convolutional layer is n*64*1*h*w=n*64*h*w.

S307: performing summation fusion on the third feature and the initial feature of the target video frame to obtain a fourth feature.

Illustratively, the third feature and the initial feature Fₜ of the target video frame may be subjected to summation fusion in a feature-channel dimension to obtain the fourth feature.

S308: processing the fourth feature by a residual dense network RDN to obtain a fifth feature.

Optionally, the RDN in the embodiments of the present invention is composed of at least one RDB.

S309: upsampling the fifth feature to obtain a super-resolution video frame corresponding to the target video frame.

Illustratively, referring to FIG. 5, FIG. 5 is a schematic structural diagram of the video frame generation module 23 illustrated in FIG. 2. As illustrated in FIG. 5, the video frame generation module 23 includes: a feature merging unit 51, a feature conversion network 52, a summation fusion unit 53, a residual dense network 54, and an upsampling unit 55; and the feature conversion network 52 includes a first convolutional layer 521, a second convolutional layer 522, and a third convolutional layer 523 that are concatenated. The process of generating a super-resolution video frame corresponding to the target video frame on the basis of the alignment feature corresponding to the RDB in each stage and the initial feature of the target video frame includes:
firstly, by the feature merging unit 51, merging alignment features (F₁^{W}, F₂^{W}, . . . , F_{D-1}^{W}, and F_{D}^{W}) corresponding to multistage RDBs to obtain a second feature FTₙ^{w};
secondarily, processing the second feature FTₙ^{w} by the first convolutional layer 521, the second convolutional layer 522, and the third convolutional layer 523 of the feature conversion network 52 sequentially, to obtain a third feature F_{tf};
thirdly, by the summation fusion unit 53, performing summation fusion on the third feature F_{tf} and the initial feature Fₜ of the target video frame to obtain a fourth feature FTₜ;
then, processing the fourth feature FTₜ by the residual dense network 54 to obtain a fifth feature FSRₜ; and
finally, by the upsampling unit 55, upsampling the fifth feature FSRₜ to obtain a super-resolution video frame HRₜ corresponding to the target video frame.

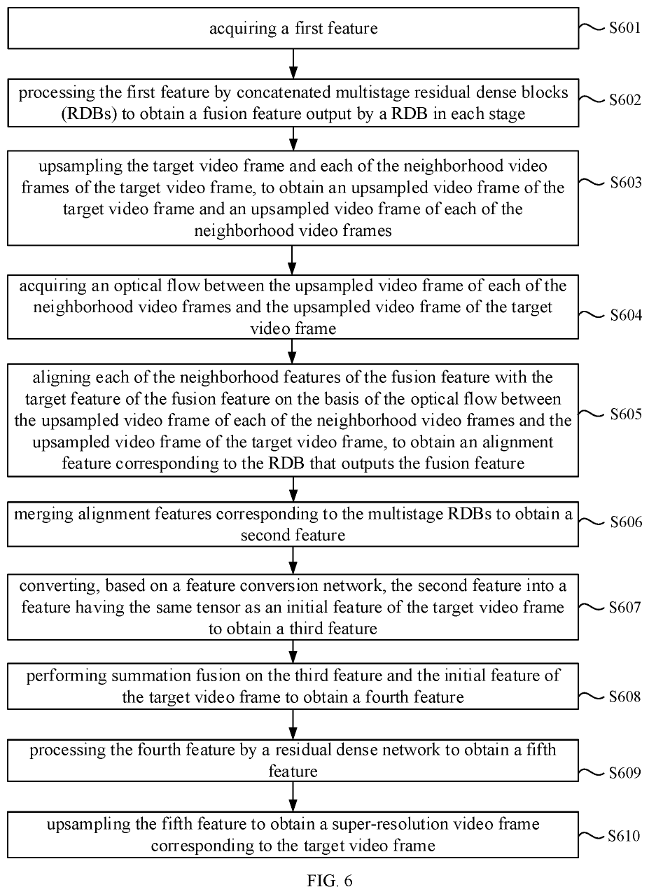

As an extension and detail of the above embodiment, an embodiment of the present invention provides another video super-resolution method, which includes the following steps as illustrated in FIG. 6:

S601: acquiring a first feature.

The first feature is a feature obtained by merging an initial feature of a target video frame and an initial feature of each of neighborhood video frames of the target video frame.

S602: processing the first feature by multistage concatenated residual dense blocks (RDBs) to obtain a fusion feature output by a RDB in each stage.

S603: upsampling the target video frame and each of the neighborhood video frames of the target video frame, to obtain an upsampled video frame of the target video frame and an upsampled video frame of each of the neighborhood video frames.

As an optional implementation of the embodiment of the present invention, that upsampling the target video frame and each of the neighborhood video frames of the target video frame may refer to: upsampling the resolution on both the length and width of the target video frame and each of the neighborhood video frames of the target video frame to two times of that of the initial video frame. That is, the resolution of the target video frame and each of the neighborhood video frames of the target video frame before upsampling is 3*h*w, and the resolution of an upsampled video frame of the target video frame obtained by upsampling and the resolution of an upsampled video frame of each of the neighborhood video frames is 3*2h*2w.

S604: acquiring an optical flow between the upsampled video frame of each of the neighborhood video frames and the upsampled video frame of the target video frame.

Similarly, it is possible to acquire the optical flow between the upsampled video frame of each of the neighborhood video frames and the upsampled video frame of the target video frame by an optical flow network.

S605: aligning each of the neighborhood features of the fusion feature with the target feature of the fusion feature on the basis of the optical flow between the upsampled video frame of each of the neighborhood video frames and the upsampled video frame of the target video frame, to obtain an alignment feature corresponding to the RDB that outputs the fusion feature.

As an optional implementation of the embodiment of the present invention, the implementation of the above step S604 may include Step a to Step e as below:

Step a: splitting the fusion feature to obtain each of the neighborhood features and the target feature.

Step b: upsampling each of the neighborhood features and the target feature respectively, to obtain an upsampled feature of each of the neighborhood video frames and an upsampled feature of the target video frame.

It should be noted that a multiple for upsampling the feature corresponding to the target video frame and the feature corresponding to each of the neighborhood video frames should be the same as a multiple for upsampling the target video frame and each of the neighborhood video frames of the target video frame in step S603.

Step c: aligning the upsampled feature of each of the neighborhood video frames with the upsampled feature of the target video frame on the basis of the optical flow between the upsampled video frame of each of the neighborhood video frames and the upsampled video frame of the target video frame, to obtain an upsampled alignment feature of each of the neighborhood video frames.

Step d: performing a space-to-depth conversion on the upsampled feature of the target video frame and the upsampled aligned feature of each of the neighborhood video frames respectively, to obtain an equivalent feature of the target video frame and an equivalent feature of each of the neighborhood video frames.

Step e: merging the equivalent feature of the target video frame and the equivalent feature of each of the neighborhood video frames, to obtain the alignment feature corresponding to the RDB that outputs the fusion features.

Referring to FIG. 7, FIG. 7 is a schematic structural diagram of a feature alignment module m in the embodiment illustrated in FIG. 2. The feature alignment module m includes: a first upsampling unit 71, an optical flow network model 72, a feature splitting unit 73, a second upsampling unit 74, a space-to-depth conversion unit 75, and a merging unit 76. The process of acquiring the alignment feature corresponding to the RDB in each stage may include:
firstly, by the first upsampling unit 71, upsampling each of the neighborhood video frames (LRₜ₋₂, LRₜ₋₁, LRₜ₊₂ and LRₜ₊₁) of the target video frame LRₜ, to obtain an upsampled video frame LRₜ^{U} of LRₜ, an upsampled video frame LRₜ₋₂^{U} of LRₜ₋₂, an upsampled video frame LRₜ₋₁^{U} of LRₜ₋₁, an upsampled video frame LRₜ₊₁^{U} of LRₜ₊₁, and an upsampled video frame LRₜ₊₂^{U} of LRₜ₊₂;
secondarily, by the optical flow network module 72, acquiring an optical flow Flowₜ₋₂^{U} between LRₜ and LRₜ₋₂^{U}, an optical flow Flowₜ₋₁^{U} between LRₜ^{U} and LRₜ₋₁^{U}, an optical flow Flowₜ₊₁^{U} between LRₜ^{U} and LRₜ₊₁^{U}, and an optical flow Flowₜ₊₂^{U} between LRₜ^{U} and LRₜ₊₂^{U};
thirdly, by the feature splitting unit 73, splitting the fusion feature Fₘ output by an mth-stage RDB into a feature F_{m, t} corresponding to the target video frame LRₜ, a feature F_{m, t-2} corresponding to the neighborhood video frame LRₜ₋₂, a feature F_{m, t-1} corresponding to the neighborhood video frame LRₜ₋₁, a feature F_{m, t+1} corresponding to the neighborhood video frame LRₜ₊₁, and a feature F_{m, t+2} corresponding to the neighborhood video frame LRₜ₊₂;
then, by the second upsampling unit 74, upsampling F_{m, t-2}, F_{m, t-1}, F_{m, t}, F_{m, t+1} and F_{m, t+2} to obtain an upsampled feature F_{m, t}^{U} of the target video frame LRₜ, an upsampled feature F_{m, t-2}^{U} of the neighborhood video frame LRₜ₋₂, an upsampled feature F_{m, t-1}^{U} of the neighborhood video frame LRₜ₋₁, an upsampled feature F_{m, t+1}^{U} of the neighborhood video frame LRₜ₊₁, and an upsampled feature of the neighborhood video frame LRₜ₊₂;
then, aligning F_{m, t+2}^{U} with F_{m, t}^{U} on the basis of the optical flow Flowₜ₊₂^{U} between LRₜ₊₂ and LRₜ to obtain an alignment feature F_{n, t+2}^{U, w}; aligning F_{m, t+1}^{U} with F_{m, t}^{U} on the basis of the optical flow Flowₜ₊₁^{U} between LRₜ₊₁ and LRₜ to obtain an alignment feature F_{n, t+2}^{U, w}; aligning F_{n, t-1}^{U} with F_{m, t}^{U} on the basis of the optical flow Flowₜ₋₁^{U} between LRₜ₋₁ and LRₜ to obtain an alignment feature F_{n, t-2}^{U, w}; and aligning F_{m, t-2}^{U} with F_{m, t}^{U} on the basis of the optical flow between LRₜ₋₂ and LRₜ to obtain an alignment feature F_{n, t-2}^{U, w};
then, by the space-to-depth conversion unit 75, converting F_{n, t+2}^{U, w}, F_{n, t+1}^{U, w}, F_{m, t}^{U}, F_{n, t-1}^{U, w}, and F_{n, t-2}^{U, w} to F_{n, t+2}^{SD, w}, F_{n, t+2}^{SD, w}, F_{m, t}^{SD}, F_{n, t-2}^{SD, w}, and F_{n, t-2}^{SD, w} respectively;
and finally, by the merging unit 76, merging F_{n, t+2}^{SD, w}, F_{n, t+1}^{SD, w}, F_{m, t}^{SD}, F_{n, t-2}^{SD, w} and F_{n, t-2}^{SD, w} to obtain an alignment feature Fₘ^{w} corresponding to the feature alignment module m.

The alignment feature corresponding to the RDB in each stage of the concatenated multistage RDBs is obtained in accordance with the method of Step a to Step e above sequentially, so that the alignment feature corresponding to the RDB in each stage is obtained.

In the above embodiment, before acquiring the optical flow between the target video frame and the neighborhood video frame, the target video frame and the neighborhood video frame are firstly upsampled, so as to amplify the target video frame and the neighborhood video frame; the optical flow is calculated based on the amplified target video frame and the neighborhood video frame, and then the feature corresponding to the target video frame and the feature corresponding to the neighborhood video frame of the upsampled RDB fusion feature are aligned with each other using the optical flow, to obtain a high-resolution alignment feature; the high-resolution alignment feature is then subjected to a space-to-depth conversion so that the high-resolution alignment feature is converted into a plurality of equivalent low-resolution features. Therefore, according to the above embodiment, P*Q optical flows (P, Q are upsampling rates over length and width respectively) can be predicted for each pixel point in each video frame, and a stability of optical flow prediction and feature alignment can be ensured by means of a redundant prediction, which further improves the video super-resolution effect.

S606: merging alignment features corresponding to the multistage RDBs to obtain a second feature.

S607: converting, based on a feature conversion network, the second feature into a feature having the same tensor as an initial feature of the target video frame to obtain a third feature.

S608: performing summation fusion on the third feature and the initial feature of the target video frame to obtain a fourth feature.

Illustratively, the third feature and the initial feature of the target video frame may be subjected to summation fusion in a feature-channel dimension to obtain the fourth feature.

S609: processing the fourth feature by a residual dense network RDN to obtain a fifth feature.

Optionally, the RDN in the embodiment of the present invention is composed of at least one RDB.

S610: upsampling the fifth feature to obtain a super-resolution video frame corresponding to the target video frame.

The implementation of the above steps S606 to S610 are similar to the implementation of the steps S305 to S309 in the embodiment illustrated in FIG. 3, referring to the above steps S305 to S309 for details, which will not be repeated here.

Based on the same inventive conception, as an implementation of the above methods, an embodiment of the present invention further provides a video super-resolution apparatus. The apparatus embodiment corresponds to the foregoing method embodiments, for ease of reading, the apparatus embodiment will not repeat the details of the foregoing method embodiments one by one. However, it should be clear that the video super-resolution apparatus in this embodiment can correspondingly implement all the contents in the foregoing method embodiments.

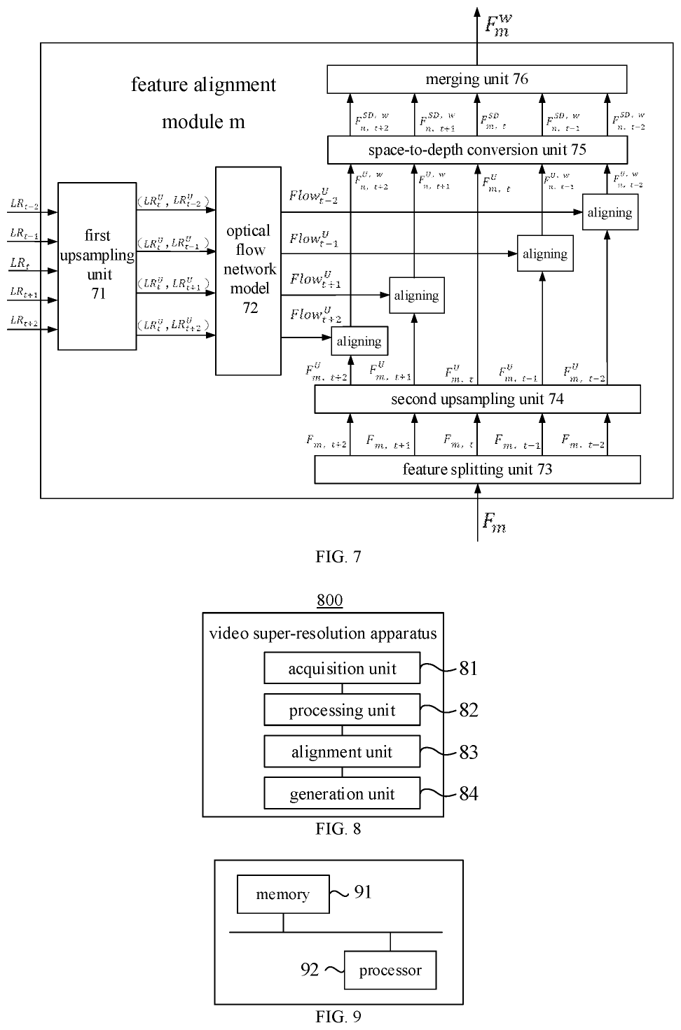

An embodiment of the present invention provides a video super-resolution apparatus, FIG. 8 is a schematic structural diagram of the video super-resolution apparatus, as illustrated in FIG. 8, the video super-resolution apparatus 800 includes:
an acquisition unit 81, configured to acquire a first feature, the first feature being a feature obtained by merging an initial feature of a target video frame and an initial feature of each of neighborhood video frames of the target video frame;
a processing unit 82, configured to process the first feature by concatenated multistage residual dense blocks (RDBs) to obtain a fusion feature output by a RDB in each stage;
an alignment unit 83, configured to, for the fusion feature output by the RDB in each stage, align each of neighborhood features of the fusion feature with a target feature of the fusion feature to obtain an alignment feature corresponding to the RDB that outputs the fusion feature, where each of the neighborhood features of the fusion feature is a feature corresponding to each of the neighborhood video frames, and the target feature of the fusion feature is a feature corresponding to the target video frame; and
a generation unit 84, configured to generate a super-resolution video frame corresponding to the target video frame on the basis of the alignment feature corresponding to the RDB in each stage and the initial feature of the target video frame.

As an optional implementation of the embodiment of the present invention, the alignment unit 83 is specifically configured to acquire an optical flow between each of the neighborhood video frames and the target video frame respectively; and align each of neighborhood features of the fusion feature with a target feature of the fusion feature on the basis of the optical flow between each of the neighborhood video frames and the target video frame, to obtain an alignment feature corresponding to the RDB that outputs the fusion feature.

As an optional implementation of the embodiment of the present invention, the alignment unit 83 is specifically configured to split the fusion feature to obtain each of the neighborhood features and the target feature; align each of the neighborhood features with the target feature on the basis of the optical flow between each of the neighborhood video frames and the target video frame, to obtain an alignment feature for each of the neighborhood video frames; and merge the target feature and the alignment feature of each of the neighborhood video frames to obtain an alignment feature corresponding to the RDB that outputs the fusion feature.

As an optional implementation of the embodiment of the present invention, the alignment unit 83 is specifically configured to upsample the target video frame and each of the neighborhood video frames of the target video frame, to obtain an upsampled video frame of the target video frame and an upsampled video frame of each of the neighborhood video frames; acquire an optical flow between the upsampled video frame of each of the neighborhood video frames and the upsampled video frame of the target video frame; and align each of the neighborhood features of the fusion feature with the target feature of the fusion feature on the basis of the optical flow between the upsampled video frame of each of the neighborhood video frames and the upsampled video frame of the target video frame, to obtain an alignment feature corresponding to the RDB that outputs the fusion feature.

As an optional implementation of the embodiment of the present invention, the alignment unit 83 is specifically configured to split the fusion feature to obtain each of the neighborhood features and the target feature; upsample each of the neighborhood features and the target feature respectively, to obtain an upsampled feature of each of the neighborhood video frames and an upsampled feature of the target video frame; align the upsampled feature of each of the neighborhood video frames with the upsampled feature of the target video frame on the basis of the optical flow between the upsampled video frame of each of the neighborhood video frames and the upsampled video frame of the target video frame, to obtain an upsampled alignment feature of each of the neighborhood video frames; perform a space-to-depth conversion on the upsampled feature of the target video frame and the upsampled aligned feature of each of the neighborhood video frames respectively, to obtain an equivalent feature of the target video frame and an equivalent feature of each of the neighborhood video frames; and merge the equivalent feature of the target video frame and the equivalent feature of each of the neighborhood video frames, to obtain an alignment feature corresponding to the RDB that outputs the fusion features.

As an optional implementation of the embodiment of the present invention, the generation unit 84 is specifically configured to merge alignment features corresponding to the multistage RDBs to obtain a second feature; convert, based on a feature conversion network, the second feature into a feature having the same tensor as an initial feature of the target video frame to obtain a third feature; and generate a super-resolution video frame corresponding to the target video frame on the basis of the third feature and the initial feature of the target video frame.

As an optional implementation of the embodiment of the present invention, the feature conversion network includes a first convolutional layer, a second convolutional layer, and a third convolutional layer concatenated sequentially;
the first convolutional layer has a kernel of 1*1*1 and has a padding parameter of 0 in each dimension; and
the second convolutional layer and the third convolutional layer both have a kernel of 3*3*3 and have a padding parameter of 0 in a time dimension and a padding parameter of 1 in both length dimension and width dimension.

An optional implementation of the embodiment of the present invention, the generation unit 84 is specifically configured to perform summation fusion on the third feature and the initial feature of the target video frame to obtain a fourth feature; process the fourth feature by a residual dense network RDN to obtain a fifth feature; and upsample the fifth feature to obtain a super-resolution video frame corresponding to the target video frame.

The video super-resolution apparatus of the embodiment may implement the video super-resolution method of the above embodiments, which has the similar implementation principle and technical effect and will not be repeated herein.

Based on the same inventive concept, an embodiment of the present invention further provides an electric device. FIG. 9 is a schematic structural diagram of an electronic device according to an embodiment of the present invention. As illustrated in FIG. 9, the electronic device provided in the embodiment includes: a memory 91 and a processor 92, the memory 91 being configured to store a computer program, the processor 92 being configured to, in the case of calling the computer program, cause the electronic device to implement the video super-resolution method of the above embodiments.

Based on the same inventive concept, an embodiment of the present invention further provides a computer-readable storage medium, the computer-readable storage medium storing a computer program which, when executed by a processor, causing the computing device to implement the video super-resolution method of the above embodiments.

Based on the same inventive concept, an embodiment of the present invention further provides a computer program product, when run on a computer, the computer program product causing the computer device to implement the video super-resolution method of the above embodiments.

It should be appreciated by those skilled in the art that the embodiments of the present invention may be provided as a method, a system, or a computer program product. Accordingly, the present invention may employ a form of fully hardware embodiments, fully software embodiments, or embodiments combining software and hardware aspects. Furthermore, the present invention can be in the form of a computer program product implemented on one or more computer-usable storage media including computer usable program code.

The processor may be a central processing unit (CPU), or another general-purpose processor, a digital signal processor (DSP), an application specific integrated circuit (ASIC), a filed-programmable gate array (FPGA) or other programmable logic devices, discrete logic devices, and other programmable logic device, a discrete gate or transistor logic device, or a discrete hardware components, and the like. The general-purpose processor may be a microprocessor, or the processor may further be any conventional processor or the like.

The memory may include a non-permanent memory in a computer-readable medium, a random access memory (RAM) and/or a non-volatile memory in the form of, for example, a read-only memory (ROM) or a flash memory (flash RAM). The memory is an example of the computer-readable medium.

The computer-readable medium includes permanent and non-permanent, removable and non-removable storage media. The storage media may be used by any method or technology to implement information storage, the information may be computer-readable instructions, data structures, program modules, or other data. Examples of the storage media for computers include, but are not limited to, a phase-change memory (PRAM), a static random-access memory (SRAM), a dynamic random-access memory (DRAM), another type of random-access memory (RAM), a read-only memory (ROM), an electrically erasable programmable read-only memory (EEPROM), a flash memory or other memory technology, a read-only CD-ROM, a digital versatile disk (DVD) or other optical storage, a magnetic cartridge tape, disk storage or other magnetic storage devices or any other non-conversion media, which can be used to store information that can be accessed by the computing device. As defined herein, the computer-readable medium does not include computer-readable transitory media, such as a modulated data signal and a carrier wave.

Finally, it should be noted that: the above embodiments are only used to illustrate the technical solutions of the present invention, and are not intended to limit the present invention. Although the present invention has been described in detail with reference to the foregoing embodiments, those of ordinary skill in the art should understand that the technical solutions recorded in the foregoing various embodiments can still be modified, or some or all of the technical features thereof may be equivalently replaced. These modifications or replacements do not cause the essence of the corresponding technical solutions to deviate from the spirit and scope of the technical solutions of the embodiments of the present invention.

1. A video super-resolution method, comprising:
acquiring a first feature, wherein the first feature is a feature obtained by merging an initial feature of a target video frame and an initial feature of each of neighborhood video frames of the target video frame;
processing the first feature by concatenated multistage residual dense blocks (RDBs) to obtain a fusion feature output by a RDB in each stage;
for the fusion feature output by the RDB in each stage, aligning each of neighborhood features of the fusion feature with a target feature of the fusion feature to obtain an alignment feature corresponding to the RDB that outputs the fusion feature, wherein each of the neighborhood features of the fusion feature is a feature corresponding to each of the neighborhood video frames, and the target feature of the fusion feature is a feature corresponding to the target video frame; and
generating a super-resolution video frame corresponding to the target video frame on the basis of the alignment feature corresponding to the RDB in each stage and the initial feature of the target video frame.

2. The method according to claim 1, wherein that aligning each of neighborhood features of the fusion feature with a target feature of the fusion feature to obtain an alignment feature corresponding to the RDB that outputs the fusion feature, comprises:
acquiring an optical flow between each of the neighborhood video frames and the target video frame respectively; and
aligning each of neighborhood features of the fusion feature with a target feature of the fusion feature on the basis of the optical flow between each of the neighborhood video frames and the target video frame, to obtain an alignment feature corresponding to the RDB that outputs the fusion feature.

3. The method according to claim 2, wherein that aligning each of neighborhood features of the fusion feature with a target feature of the fusion feature on the basis of the optical flow between each of the neighborhood video frames and the target video frame, to obtain an alignment feature corresponding to the RDB that outputs the fusion feature, comprises:
splitting the fusion feature to obtain each of the neighborhood features and the target feature;
aligning each of the neighborhood features with the target feature on the basis of the optical flow between each of the neighborhood video frames and the target video frame, to obtain an alignment feature for each of the neighborhood video frames; and
merging the target feature and the alignment feature of each of the neighborhood video frames to obtain an alignment feature corresponding to the RDB that outputs the fusion feature.

4. The method according to claim 1, wherein that aligning each of neighborhood features of the fusion feature with a target feature of the fusion feature to obtain an alignment feature corresponding to the RDB that outputs the fusion feature, comprises:
upsampling the target video frame and each of the neighborhood video frames of the target video frame, to obtain an upsampled video frame of the target video frame and an upsampled video frame of each of the neighborhood video frames;
acquiring an optical flow between the upsampled video frame of each of the neighborhood video frames and the upsampled video frame of the target video frame; and
aligning each of the neighborhood features of the fusion feature with the target feature of the fusion feature on the basis of the optical flow between the upsampled video frame of each of the neighborhood video frames and the upsampled video frame of the target video frame, to obtain an alignment feature corresponding to the RDB that outputs the fusion feature.

5. The method according to claim 4, wherein that aligning each of the neighborhood features of the fusion feature with the target feature of the fusion feature on the basis of the optical flow between the upsampled video frame of each of the neighborhood video frames and the upsampled video frame of the target video frame, to obtain an alignment feature corresponding to the RDB that outputs the fusion feature, comprises:
splitting the fusion feature to obtain each of the neighborhood features and the target feature;
upsampling each of the neighborhood features and the target feature respectively, to obtain an upsampled feature of each of the neighborhood video frames and an upsampled feature of the target video frame;
aligning the upsampled feature of each of the neighborhood video frames with the upsampled feature of the target video frame on the basis of the optical flow between the upsampled video frame of each of the neighborhood video frames and the upsampled video frame of the target video frame, to obtain an upsampled alignment feature of each of the neighborhood video frames;
performing a space-to-depth conversion on the upsampled feature of the target video frame and the upsampled aligned feature of each of the neighborhood video frames respectively, to obtain an equivalent feature of the target video frame and an equivalent feature of each of the neighborhood video frames; and
merging the equivalent feature of the target video frame and the equivalent feature of each of the neighborhood video frames, to obtain an alignment feature corresponding to the RDB that outputs the fusion features.

6. The method according to claim 1, wherein that generating a super-resolution video frame corresponding to the target video frame on the basis of the alignment feature corresponding to the RDB in each stage and the initial feature of the target video frame, comprises:
merging alignment features corresponding to the multistage RDBs to obtain a second feature;
converting, based on a feature conversion network, the second feature into a feature having the same tensor as an initial feature of the target video frame to obtain a third feature; and
generating a super-resolution video frame corresponding to the target video frame on the basis of the third feature and the initial feature of the target video frame.

7. The method according to claim 6, wherein the feature conversion network comprises a first convolutional layer, a second convolutional layer, and a third convolutional layer concatenated sequentially;
the first convolutional layer has a kernel of 1*1*1 and has a padding parameter of 0 in each dimension; and
the second convolutional layer and the third convolutional layer both have a kernel of 3*3*3 and have a padding parameter of 0 in a time dimension and a padding parameter of 1 in both length dimension and width dimension.

8. The method according to claim 6, wherein that generating a super-resolution video frame corresponding to the target video frame on the basis of the third feature and the initial feature of the target video frame, comprises:
performing summation fusion on the third feature and the initial feature of the target video frame to obtain a fourth feature;
processing the fourth feature by a residual dense network RDN to obtain a fifth feature; and
upsampling the fifth feature to obtain a super-resolution video frame corresponding to the target video frame.

9. (canceled)

10. An electronic device, comprising a memory and a processor, the memory being configured to store a computer program, the processor being configured to, when executing the computer program, cause the electronic device to implement:
acquiring a first feature, wherein the first feature is a feature obtained by merging an initial feature of a target video frame and an initial feature of each of neighborhood video frames of the target video frame;
processing the first feature by concatenated multistage residual dense blocks (RDBs) to obtain a fusion feature output by a RDB in each stage;
for the fusion feature output by the RDB in each stage, aligning each of neighborhood features of the fusion feature with a target feature of the fusion feature to obtain an alignment feature corresponding to the RDB that outputs the fusion feature, wherein each of the neighborhood features of the fusion feature is a feature corresponding to each of the neighborhood video frames, and the target feature of the fusion feature is a feature corresponding to the target video frame; and
generating a super-resolution video frame corresponding to the target video frame on the basis of the alignment feature corresponding to the RDB in each stage and the initial feature of the target video frame.

11. A computer-readable storage medium, the computer-readable storage medium storing a computer program which, when executed by a computing device, causing the computing device to implement;
acquiring a first feature, wherein the first feature is a feature obtained by merging an initial feature of a target video frame and an initial feature of each of neighborhood video frames of the target video frame;
processing the first feature by concatenated multistage residual dense blocks (RDBs) to obtain a fusion feature output by a RDB in each stage;
for the fusion feature output by the RDB in each stage, aligning each of neighborhood features of the fusion feature with a target feature of the fusion feature to obtain an alignment feature corresponding to the RDB that outputs the fusion feature, wherein each of the neighborhood features of the fusion feature is a feature corresponding to each of the neighborhood video frames, and the target feature of the fusion feature is a feature corresponding to the target video frame; and
generating a super-resolution video frame corresponding to the target video frame on the basis of the alignment feature corresponding to the RDB in each stage and the initial feature of the target video frame.

12. (canceled)

13. The electronic device according to claim 10, wherein the processor is configured to, when executing the computer program, cause the electronic device to further implement:
acquiring an optical flow between each of the neighborhood video frames and the target video frame respectively; and
aligning each of neighborhood features of the fusion feature with a target feature of the fusion feature on the basis of the optical flow between each of the neighborhood video frames and the target video frame, to obtain an alignment feature corresponding to the RDB that outputs the fusion feature.

14. The electronic device according to claim 13, wherein the processor is configured to, when executing the computer program, cause the electronic device to further implement:
splitting the fusion feature to obtain each of the neighborhood features and the target feature;
aligning each of the neighborhood features with the target feature on the basis of the optical flow between each of the neighborhood video frames and the target video frame, to obtain an alignment feature for each of the neighborhood video frames; and
merging the target feature and the alignment feature of each of the neighborhood video frames to obtain an alignment feature corresponding to the RDB that outputs the fusion feature.

15. The electronic device according to claim 10, wherein the processor is configured to, when executing the computer program, cause the electronic device to further implement:
upsampling the target video frame and each of the neighborhood video frames of the target video frame, to obtain an upsampled video frame of the target video frame and an upsampled video frame of each of the neighborhood video frames;
acquiring an optical flow between the upsampled video frame of each of the neighborhood video frames and the upsampled video frame of the target video frame; and
aligning each of the neighborhood features of the fusion feature with the target feature of the fusion feature on the basis of the optical flow between the upsampled video frame of each of the neighborhood video frames and the upsampled video frame of the target video frame, to obtain an alignment feature corresponding to the RDB that outputs the fusion feature.

16. The electronic device according to claim 15, wherein the processor is configured to, when executing the computer program, cause the electronic device to further implement:
splitting the fusion feature to obtain each of the neighborhood features and the target feature;
upsampling each of the neighborhood features and the target feature respectively, to obtain an upsampled feature of each of the neighborhood video frames and an upsampled feature of the target video frame;
aligning the upsampled feature of each of the neighborhood video frames with the upsampled feature of the target video frame on the basis of the optical flow between the upsampled video frame of each of the neighborhood video frames and the upsampled video frame of the target video frame, to obtain an upsampled alignment feature of each of the neighborhood video frames;
performing a space-to-depth conversion on the upsampled feature of the target video frame and the upsampled aligned feature of each of the neighborhood video frames respectively, to obtain an equivalent feature of the target video frame and an equivalent feature of each of the neighborhood video frames; and
merging the equivalent feature of the target video frame and the equivalent feature of each of the neighborhood video frames, to obtain an alignment feature corresponding to the RDB that outputs the fusion features.

17. The electronic device according to claim 10, wherein the processor is configured to, when executing the computer program, cause the electronic device to further implement:
merging alignment features corresponding to the multistage RDBs to obtain a second feature;
converting, based on a feature conversion network, the second feature into a feature having the same tensor as an initial feature of the target video frame to obtain a third feature; and
generating a super-resolution video frame corresponding to the target video frame on the basis of the third feature and the initial feature of the target video frame.

18. The electronic device according to claim 17, wherein the feature conversion network comprises a first convolutional layer, a second convolutional layer, and a third convolutional layer concatenated sequentially;
the first convolutional layer has a kernel of 1*1*1 and has a padding parameter of 0 in each dimension; and
the second convolutional layer and the third convolutional layer both have a kernel of 3*3*3 and have a padding parameter of 0 in a time dimension and a padding parameter of 1 in both length dimension and width dimension.

19. The electronic device according to claim 10, wherein the processor is configured to, when executing the computer program, cause the electronic device to further implement:
performing summation fusion on the third feature and the initial feature of the target video frame to obtain a fourth feature;
processing the fourth feature by a residual dense network RDN to obtain a fifth feature; and
upsampling the fifth feature to obtain a super-resolution video frame corresponding to the target video frame.

20. The computer-readable storage medium according to claim 11, wherein the computer program which, when executed by a computing device, causes the computing device to further implement:
acquiring an optical flow between each of the neighborhood video frames and the target video frame respectively; and
aligning each of neighborhood features of the fusion feature with a target feature of the fusion feature on the basis of the optical flow between each of the neighborhood video frames and the target video frame, to obtain an alignment feature corresponding to the RDB that outputs the fusion feature.
